(19) United States
(12) Patent Application Publication
(10) Pub. No.: US 2016/0028713 A1
(43) Pub. Date: Jan. 28, 2016

(54) Universal Serial Bus (USB) Flash Drive Security System And Method

(71) Applicant: Beautiful Enterprise Co., Ltd., Hong Kong (HK)

(72) Inventors: Chung Yeung CHUI, Hong Kong (HK); Kwok Keung YAM, Hong Kong (HK); So Lam SZE, Hong Kong (HK); Kin Yip WONG, Hong Kong (HK)

(21) Appl. No.: 14/337,656

(22) Filed: Jul. 22, 2014

(51) Int. Cl. H04L 29/06

(52) U.S. Cl. CPC H04L 63/083; H04L 63/126

(57) ABSTRACT

A universal serial bus (USB) flash drive security system includes a smart phone 32 and a USB flash drive 10 adapted to be in a data communicable relationship with the smart phone 32. When the USB flash drive 10 is connected with a personal computer 30, the smart phone 32 may authorize the USB flash drive 10 to allow data in the USB flash drive 10 to be accessed by the personal computer 30.

### TECHNICAL FIELD

This invention relates to a universal serial bus (USB) flash drive (also called a “USB thumb drive”) security system and method, in particular, such a system and method using a data communication apparatus, such as a mobile phone, e.g. a smart phone.

### BACKGROUND OF THE INVENTION

USB flash drives are commonly available, allowing easy storage and retrieval of data by various data processing apparatus having at least one USB receptacle/socket, such as personal computers (PCs), laptop computers and tablet computers. Each such USB flash drive includes a flash memory and a port/plug. When the port of the USB flash drive is connected with a receptacle of a data processing apparatus, data may be stored into or retrieved from the flash memory of the USB flash drive by the data processing apparatus.

Ways have been devised to prevent unauthorized access to the data in USB flash drives. Currently, USB flash drive content protection is implemented by the following approaches:

(a) finger print authentication: a user is required to have his/her finger print scanned and relevant encrypted finger print data stored in the USB flash drive. Subsequent access to the content of the USB flash drive is allowed upon matching of the user's finger print with the encrypted finger print data stored in the USB flash drive, and

(b) password protection between the USB flash drive and the software installed on the data processing apparatus (e.g. a personal computer) to which the USB flash drive is to be connected for access. A password is entered by a user, which password being subsequently encrypted and stored in both the software on the data processing apparatus and the USB flash drive. When the USB flash drive is plugged into the data processing apparatus, the software on the data processing apparatus will prompt the user to enter the password, so as to allow access to the data in the USB flash drive.

The former approach is cumbersome at least in that means has to be available for scanning the finger print of the user every time the USB flash drive is to accessed. As for the latter approach, the USB flash drive simply cannot be accessed by a data processing apparatus not installed with the software. This significantly limits the convenience of use of the USB flash drive.

It is thus an object of the present invention to provide a universal serial bus (USB) flash drive security system, a USB flash drive security method and a USB flash drive in which the aforesaid shortcomings are mitigated or at least to provide a useful alternative to the trade and public.

### SUMMARY OF THE INVENTION

According to a first aspect of the present invention, there is provided a universal serial bus (USB) flash drive security system including a data communication apparatus, and a USB flash drive adapted to be in a data-communicable relationship with said data communication apparatus, wherein, when said USB flash drive is connected with a data processing apparatus, said data communication apparatus is adapted to authorize said USB flash drive to allow data in said USB flash drive to be accessed by said data processing apparatus.

According to a second aspect of the present invention, there is provided a universal serial bus (USB) flash drive security method including steps (a) providing a data communication apparatus, (b) providing a USB flash drive adapted to be in a data-communicable relationship with said data communication apparatus, (c) connecting said USB flash drive with a data processing apparatus, and (d) said data communication apparatus communicating with said USB flash drive to authorize USB flash drive to allow data in said USB flash drive to be accessed by said data processing apparatus.

According to a third aspect of the present invention, there is provided a universal serial bus (USB) flash drive including a Bluetooth® Low Energy chip.

### BRIEF DESCRIPTION OF THE DRAWINGS

Embodiments of the present invention will now be described, by way of examples only, with reference to the accompanying drawings, in which:

FIG. 1 is a schematic view of a USB flash drive according to the present invention;

FIG. 2 is a schematic diagram of the USB flash drive of FIG. 1 on a hardware level;

FIGS. 3 to 6 show schematically operation of a USB flash drive security system and method according to the present invention;

FIG. 7 shows the steps of first time use of the USB flash drive of FIG. 1 and operation of the USB drive at two different protection levels;

FIG. 8A shows the steps of pairing the USB flash drive of FIG. 1 to another smart phone;

FIG. 8B shows the steps of changing the protection level at which the USB flash drive of FIG. 1 operates; and

FIG. 8C show the steps of changing the password.

### DETAILED DESCRIPTION OF THE INVENTION

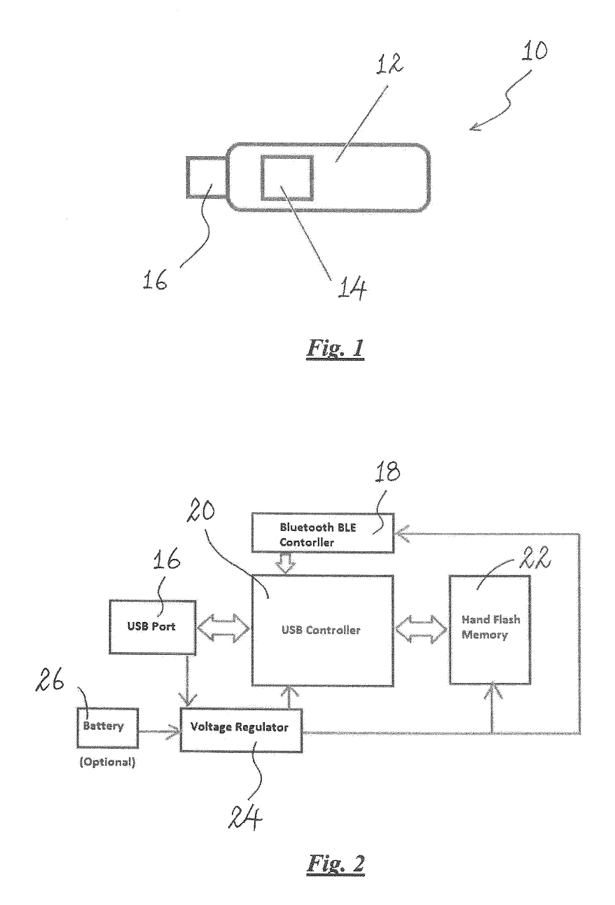

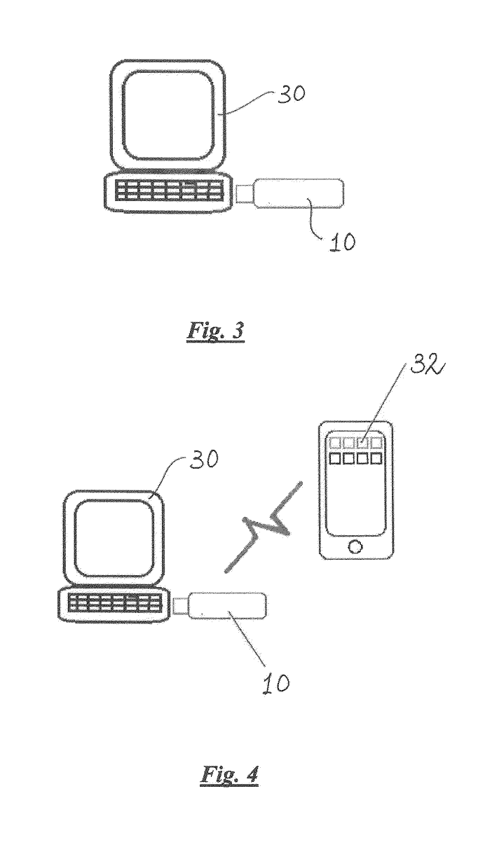

A universal serial bus (USB) flash drive according to an embodiment of the present invention is shown in FIG. 1, and generally designated as 10. The USB flash drive 10 has a body 12 embedded with a Bluetooth® Low Energy chip or module 14, providing means for wirelessly communicating with a smart phone of a user via Bluetooth® connection after pairing (to be discussed below). The USB flash drive 10 also includes a USB port 16 which is connectable with and receivable by a corresponding USB receptacle of a data processing apparatus, such as personal computers (PCs), laptop computers and tablet computers, to enable data and power connection between the data processing apparatus and the USB flash drive 10.

As shown in FIG. 2, in addition to the USB port 16, the USB flash drive 10 also has the following components:

(a) a Bluetooth® BLE (Bluetooth® Low Energy) Controller 18:
for controlling Bluetooth® wireless connectivity functions between the USB flash drive 10 and the smart phone of the user, including the pairing process;
for enabling wireless link via Bluetooth® for password checking on first time usage,
for storage of a password,
for authorizing a USB Controller (to be discussed below) to allow the transfer of data/content between the USB flash drive 10 and the data processing apparatus. In particular, the Bluetooth® BLE Controller 18 will, upon successful authentication, send enable signal for data read/write to the USB Controller to authorize the USB Controller to allow data transfer between the USB flash drive 10 and the data processing apparatus,

(b) a USB Controller 20: for controlling the transfer of data/content between the USB flash drive 10 and the data processing apparatus, after access of the USB flash drive 10 by the data processing apparatus is authorized,

(c) a Hand Flash Memory 22: a storage memory for storage of data/content,

(d) a Voltage Regulator 24 (which may also be called a Power Regulator): for accepting power from the data processing apparatus via the USB port 16 or from a battery in the USB flash drive 10 (to be discussed below) for providing regulated power/voltage to the controller 18 and memory 22, and

(e) optionally, a battery 26 for powering the USB flash drive 10.

In the present embodiment, the USB flash drive 10 is to be connected with a personal computer 30, although it should be understood that the USB flash drive 10 may be connected with other data processing apparatus with a USB receptacle. When the USB flash drive 10 is connected with the personal computer 30, it is powered by the personal computer 30 or by the battery 26 (if available) of the USB flash drive 10.

In the present embodiment, a data communication apparatus in a form of a smart phone 32 with Bluetooth® capability and suitable application software (called “App”) is in a data-communicable relationship with the chip 14 of the USB flash drive 10 in a non-contact manner, e.g. wirelessly, in particular based on the proximity protocol of Bluetooth® Low Energy connection technology.

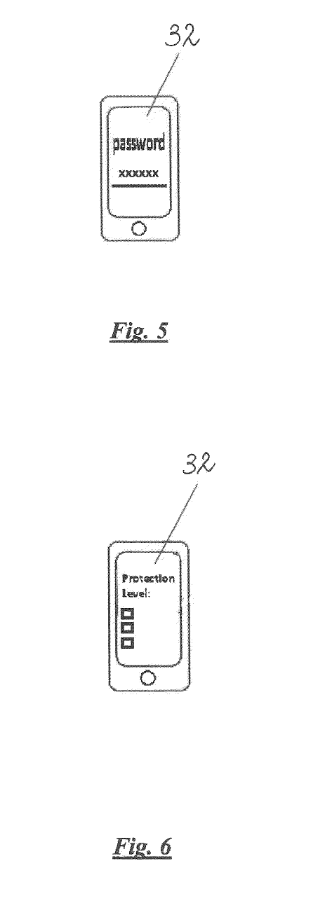

Referring now to FIGS. 5 to 7, when the USB flash drive 10 is used for the first time, a user has to pair the smart phone 32 with the USB flash drive 10 by launching 102 the App. In particular, the user brings the smart phone 32 and the USB flash drive 10 within the valid Bluetooth® distance range to establish wireless link between the smart phone 32 and the USB flash drive 10 based on the proximity protocol of Bluetooth® Low Energy connection technology. When wireless link is established between the smart phone 32 and the USB flash drive 10, the APP will cause the smart phone 32 to detect whether the USB flash drive 10 is used for the first time.

If it is confirmed that the USB flash drive 10 is used for the first time, the App will prompt (via the smart phone 32) the user to set 104 a password and the protection level at which the USB flash drive 10 is to operate. The password set by the user will be encrypted and stored in the Bluetooth® BLE Controller 18 of the USB flash drive 10. After the setting of the password, the App will prompt (via the smart phone 32) the user to select/set the protection level at which the USB flash drive 10 is to operate.

After the password and the protection level have been set, once the USB flash drive 10 is plugged onto the USB receptacle/slot of the personal computer 30, the firmware in the USB flash drive 10 will initiate an authorization process, depending on the protection level selected by the user.

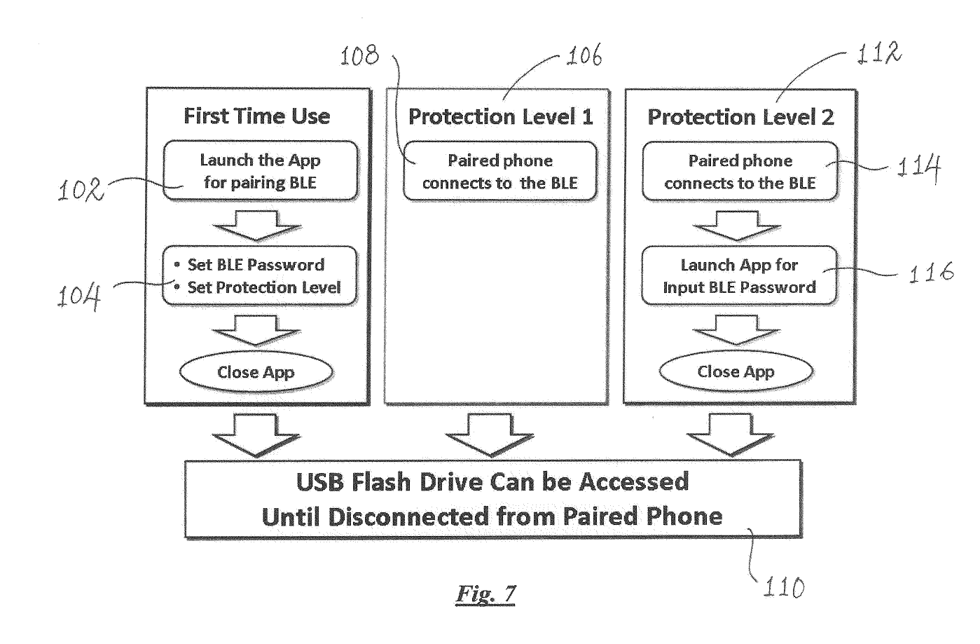

There are three protection levels available for selection by the user. A first protection level is “Protection Level 0” (not shown in FIG. 7), which is in fact a no-protection level. When the USB flash drive 10 is set to operate at this protection level, it functions as a conventional USB flash drive, which can be accessed by any data processing apparatus to which it is plugged/connected. No working of the App is required for accessing the data stored in the USB flash drive 10, and data may be freely transferred between the USB flash drive 10 and the data processing apparatus to which it is plugged/connected.

A second protection level is “Protection Level 1” 106. When the USB flash drive 10 is set to work at this protection level, only proximity of the smart phone 32 and working of the App are required for authorizing the USB flash drive 10 to allow access to its data/content by the personal computer 30 to which it is plugged/connected. More particularly, when the USB flash drive 10 is connected with the personal computer 30, the personal computer 30 cannot automatically gain access to the content/data stored in the USB flash drive 10. The user is required to launch the App. Alternatively, the system may have been initialized, thus having the App running in the background.

If the user brings the smart phone 32 towards the USB flash drive 10 to within a distance (e.g. 3 metres) pre-set by the user, the firmware inside the USB flash drive 10 and the App on the smart phone 32 will pair 108 the smart phone 32 and the USB flash drive 10, and start the authorization process by interacting with each other. Upon successful connection and interaction between the USB flash drive 10 and the smart phone 32, the BLE Controller 18 will authorize the USB flash drive 10 to allow access to its data/content by the personal computer 30 until the smart phone 32 is moved away from the USB flash drive 10 beyond the pre-set distance, thus being disconnected 110 from the USB flash drive 10. This mode of operation is convenient to the user as no password has to be entered by him/her.

A third protection level is “Protection Level 2” 112. When the USB flash drive 10 is set to work at this protection level, both proximity and password are required to allow access to the data/content stored in the USB flash drive 10. When the USB flash drive 10 set to work at this protection level is connected with the personal computer 30, the personal computer 30 cannot automatically gain access to the content/data stored in the USB flash drive 10. The user is required to launch the App. Alternatively, the system may have been initialized, thus having the App running in the background.

If the smart phone 32 is brought towards the USB flash drive 10 to within the valid Bluetooth® distance, the firmware inside the USB flash drive 10 and the App on the smart phone 32 will pair 114 the smart phone 32 and the USB flash drive 10, and start the authorization process by interacting with each other. The App will prompt the user to enter the password 116. The password is then transmitted to the USB flash drive 10 to be checked against the pre-set password stored in the USB flash drive 10. If the keyed-in password transmitted to the USB flash drive 10 matches the pre-set password stored in the USB flash drive 10, the BLE Controller 18 will authorize the USB flash drive 10 to allow access to its data/content by the personal computer 30 until the USB flash drive 10 is disconnected from the personal computer 30. An advantage of this mode of operation is that security is enhanced, as it also requires input of a password in addition to proximity of the smart phone 32, thus reducing the risk of access to the content in the USB flash drive 10 if, for example, the smart phone 32 has been stolen.

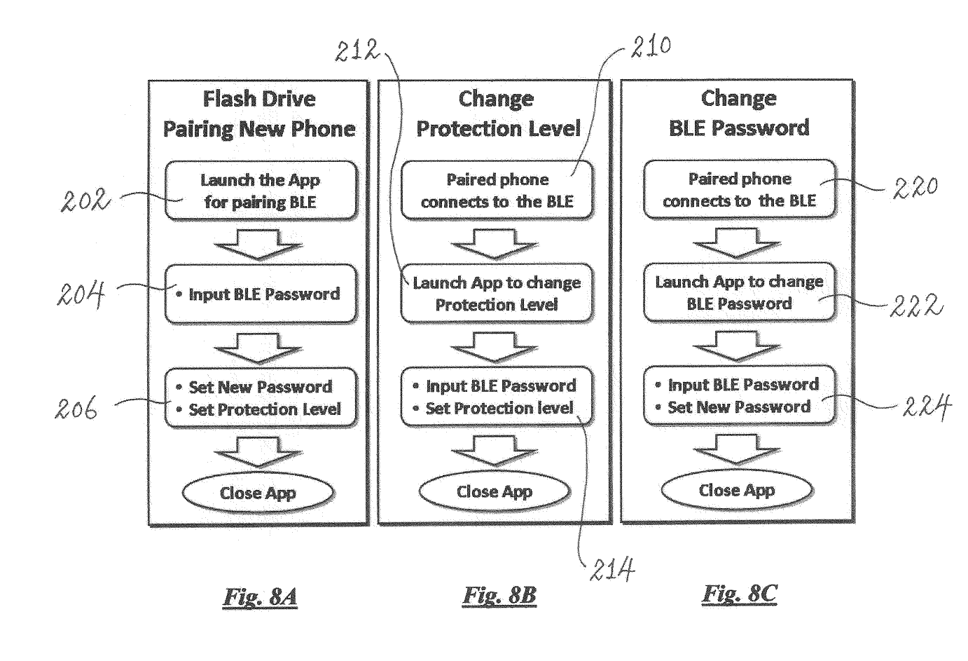

As shown in FIG. 8A, it is possible to pair the USB flash drive 10 with another smart phone (called the “new smart phone”) installed with the relevant App. The new smart phone launches 202 the App for pairing with the USB flash drive 10 via the proximity protocol of Bluetooth® Low Energy connection technology. The user then enters 204 the pre-set password. To pair the new smart phone with the USB flash drive 10, the user then sets 206 a new password and a protection level, to be transmitted to and stored in the USB flash drive, for subsequent operation. Pairing of the new smart phone with the USB flash drive 10 is then completed.

As shown in FIG. 8B, it is possible to change the protection level at which the USB flash drive 10 is to operate. The user firstly connects 210 the paired smart phone 32 with the USB flash drive 10 via the proximity protocol of Bluetooth® Low Energy connection technology. The smart phone 32 then launches 212 the App to allow change of the protection level. The user then inputs the pre-set password and then changes the protection level 214, as desired. Particularly, the App will display choices of protection level on the smart phone 32, and the choice of the protection level will be transmitted to the USB flash drive 10 for storage and subsequent operation.

As shown in FIG. 8C, it is possible to change the password. The user firstly connects 220 the paired smart phone 32 with the USB flash drive 10 via the proximity protocol of Bluetooth® Low Energy connection technology. The smart phone 32 then launches 222 the App to allow change of the password. The user then inputs the pre-set password and then changes the password 224, as desired. Particularly, the App will display means of entry of a new password (e.g. a virtual keyboard or number pad) on the smart phone 32, and new password will be transmitted to the USB flash drive 10 for storage and subsequent operation.

It should be understood that the above only illustrates examples whereby the present invention may be carried out, and that various modifications and/or alterations may be made thereto without departing from the spirit of the invention. For example, the present security system and method may be used as the primary security measure for protection of the content of the USB flash drive, or may be combined with other approach(es) as a secondary security measure. In addition, although the invention has thus far been discussed in the context of the data communication apparatus being a smart phone, it is envisaged that other data communication apparatus (e.g. radio frequency wireless transceivers) may be used, in which case the chip in the USB flash drive has to be one compatible with the data communication apparatus in terms of the mode of non-contact communication.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. A universal serial bus (USB) flash drive security system including:
a data communication apparatus, and
a USB flash drive adapted to be in a data-communicable relationship with said data communication apparatus,
wherein, when said USB flash drive is connected with a data processing apparatus, said data communication apparatus is adapted to authorize said USB flash drive to allow data in said USB flash drive to be accessed by said data processing apparatus.

2. The system according to claim 1 wherein said USB flash drive and said data communication apparatus are data-communicable with each other in a non-contact manner.

3. The system according to claim 2 wherein said USB flash drive and said data communication apparatus are data-communicable with each other based on proximity protocol of Bluetooth® Low Energy connection technology.

4. The system according to claim 1 wherein said USB flash drive includes a Bluetooth® Low Energy chip.

5. The system according to claim 1 wherein said data communication apparatus includes a smart phone.

6. The system according to claim 1 wherein said data communication apparatus is adapted to transmit a pre-set password to said USB flash drive to authorize said USB flash drive to allow data in said USB flash drive to be accessed by said data processing apparatus.

7. A universal serial bus (USB) flash drive security method comprising the steps of:
(a) providing a data communication apparatus,
(b) providing a USB flash drive adapted to be in a data-communicable relationship with said data communication apparatus,
(c) connecting said USB flash drive with a data processing apparatus, and
(d) said data communication apparatus communicating with said USB flash drive to authorize USB flash drive to allow data in said USB flash drive to be accessed by said data processing apparatus.

8. The method according to claim 7 wherein in said step (d) said USB flash drive and said data communication apparatus communicate with each other in a non-contact manner.

9. The method according to claim 8 wherein in said step (d) said USB flash drive and said data communication apparatus communicate with each other based on proximity protocol of Bluetooth® Low Energy connection technology.

10. The method according to claim 7 wherein said data communication apparatus includes a smart phone.

11. The method according to claim 7 wherein in said step (d) said data communication apparatus transmits a password to said USB flash drive to authorize said USB flash drive to allow data in said USB flash drive to be accessed by said data processing apparatus.

12. The method according to claim 7 further comprising a step (e), prior to step (a), of pairing said USB flash drive and said data communication apparatus.

13. The method according to claim 12 wherein said step (e) includes setting a password.

14. The method according to claim 13 further comprising a step (j) of changing said password.

15. The method according to claim 12 further comprising a step (f) of setting said USB flash drive to operate in one of at least a first protection level and a second protection level.

16. The method according to claim 15 further comprising a step (g) of said data communication apparatus communicating with said USB flash drive to authorize USB flash drive to allow data in said USB flash drive to be accessed by said data processing apparatus when said USB flash drive is set to operate in said first protection level and when said data communication apparatus is within a predetermined distance from said USB flash drive.

17. The method according to claim 16 wherein said predetermined distance is settable by said user.

18. The method according to claim 15 further comprising a step (h) of entering said password into said data communication apparatus and a step (i) of said data communication apparatus transmitting a password to said USB flash drive to authorize said USB flash drive to allow data in said USB flash drive to be accessed by said data processing apparatus when said USB flash drive is set to operate in said second protection level and when said data communication apparatus is within a predetermined distance from said USB flash drive.

19. The method according to claim 15 further including a step (k) of changing the protection level at which said USB flash drive operates.

20. The universal serial bus (USB) flash drive including a Bluetooth® Low Energy chip.
